(19) United States
(12) Patent Application Publication
(10) Pub. No.: US 2009/0303193 A1
(43) Pub. Date: Dec. 10, 2009

(54) TOUCH SCREEN DISPLAY DEVICE

(76) Inventors: Myong-Bin LIM, Seoul (KR); Sun-Kyu SON, Suwon-si (KR)

Correspondence Address: Haynes and Boone, LLP;IP Section, 2323 Victory Avenue, SUITE 700, Dallas, TX, 75219, US

(21) Appl. No.: 12/272,634

(22) Filed: Nov. 17, 2008

(30) Foreign Application Priority Data
Jun. 9, 2008 (KR) 10-2008-0053859

(51) Int. Cl. G06F 3/041; G09G 5/00

(52) U.S. Cl. 345/173; 345/204

(57) ABSTRACT

In accordance with one or more embodiments of the present disclosure, a touch screen display device includes a touch screen display panel, a first integrated circuit (IC) chip, and a second IC chip. The touch screen display panel includes a plurality of gate lines, a plurality of data lines, a plurality of pixels, a plurality of first sensing lines, a plurality of second sensing lines, and a plurality of touch sensors. The first IC chip includes a gate driver which transmits a plurality of gate signals to the gate lines, respectively, and a first read-out unit which receives respective output signals of the first sensing lines. The second IC chip includes a data driver which applies a plurality of image data voltages to the data lines, respectively, and a second read-out unit which receives respective output signals of the second sensing lines.

### RELATED APPLICATIONS

This application claims priority to and benefit of Korean Patent Application No. 10-2008-0053859, filed on Jun. 9, 2008 in the Korean Intellectual Property Office, the disclosure of which is incorporated herein by reference in its entirety.

### BACKGROUND

1. Technical Field

The present invention relates to a touch screen display device, and more particularly, to a touch screen display device which may be manufactured at reduced costs.

2. Related Art

Generally, a touch screen display device includes a display device having a touch screen operation. A user may touch a point on the touch screen display device to instruct the touch screen display device to perform a desired task. Since display devices having the touch screen function provide an intuitive interface by which users may easily input information, they are widely being used.

A touch screen display device includes a plurality of pixels for displaying images and a plurality of touch sensors for sensing points touched by a user. A gate signal and a data signal are transmitted to each pixel, and each touch sensor provides an output signal according to whether the touch screen display device has been touched. As such, the touch screen display device utilizes a gate driver that provides gate signals, a data driver that provides data signals, and a read-out unit that reads an output signal of each touch sensor.

### SUMMARY

One or more embodiments of the present disclosure provide a touch screen display device that may be manufactured at reduced costs. However, it should be appreciated that various aspects of the present disclosure should not be restricted to any particular one set forth herein. The above and other aspects of the present disclosure will become more apparent to one of ordinary skill in the art to which the present disclosure pertains by referencing the detailed description of the present disclosure given below.

According to an aspect of the present disclosure, there is provided a touch screen display device including a touch screen display panel, a first integrated circuit (IC) chip, and a second IC chip. The touch screen display panel includes a plurality of gate lines which extend in a first direction, a plurality of data lines which extend in a second direction that crosses the first direction, a plurality of pixels which are defined in regions where the gate lines and the data lines cross each other, respectively, a plurality of first sensing lines which extend substantially parallel to the first direction, a plurality of second sensing lines which extend substantially parallel to the second direction, and a plurality of touch sensors which are defined in regions where the first sensing lines and the second sensing lines cross each other, respectively. The first IC chip includes a gate driver which transmits a plurality of gate signals to the gate lines, respectively, and a first read-out unit which receives respective output signals of the first sensing lines. The second IC chip includes a data driver which applies a plurality of image data voltages to the data lines, respectively, and a second read-out unit which receives respective output signals of the second sensing lines.

According to another aspect of the present disclosure, there is provided a touch screen display device including a touch screen display panel, a first IC chip, and a second IC chip. The touch screen display panel includes a plurality of gate lines which extend in a first direction, a plurality of data lines which extend in a second direction that crosses the first direction, a plurality of pixels which are defined in regions where the gate lines and the data lines cross each other, respectively, a plurality of first sensing lines which extend substantially parallel to the first direction, a plurality of second sensing lines which extend substantially parallel to the second direction, a plurality of touch sensors which are defined in regions where the first sensing lines and the second sensing lines cross each other, respectively, and a gate driver which transmits the gate signals to the gate lines, respectively. The first IC chip includes a first read-out unit which receives respective output signals of the first sensing lines. The second IC chip includes a data driver which applies a plurality of image data voltages to the data lines, respectively, and a second read-out unit which receives respective output signals of the second sensing lines.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram of a touch screen display device according to an exemplary embodiment of the present disclosure;

FIG. 2 is the layout of a first display panel included in a touch screen display panel of FIG. 1, in accordance with an embodiment of the present disclosure;

FIG. 3 is the layout of a second display panel included in the touch screen display panel of FIG. 1, in accordance with an embodiment of the present disclosure;

FIG. 4 is a cross-sectional view of the touch screen display panel of FIG. 1 taken along a line IIb-IIb′ of FIG. 2, in accordance with an embodiment of the present disclosure;

FIG. 5 is a cross-sectional view of the touch screen display panel for explaining a process of inputting location information by pressing a point on the touch screen display panel of FIG. 4, in accordance with an embodiment of the present disclosure;

FIG. 6 is a block diagram for explaining first and second sensing lines and first and second read-out units, in accordance with an embodiment of the present disclosure;

FIG. 7 is a circuit diagram for explaining a sensing line of FIG. 6 and a level detector connected to the sensing line, in accordance with an embodiment of the present disclosure;

FIGS. 8A and 8B are timing diagrams of signals which are input or output to/from the first and second read-out units of FIG. 6, in accordance with an embodiment of the present disclosure; and

FIG. 9 is a block diagram of a touch screen display device according to another exemplary embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that when an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third, etc., may be used herein to describe various elements, components and/or sections, these elements, components and/or sections should not be limited by these terms. These terms are only used to distinguish one element, component or section from another element, component or section. Thus, a first element, component or section discussed below could be termed a second element, component or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

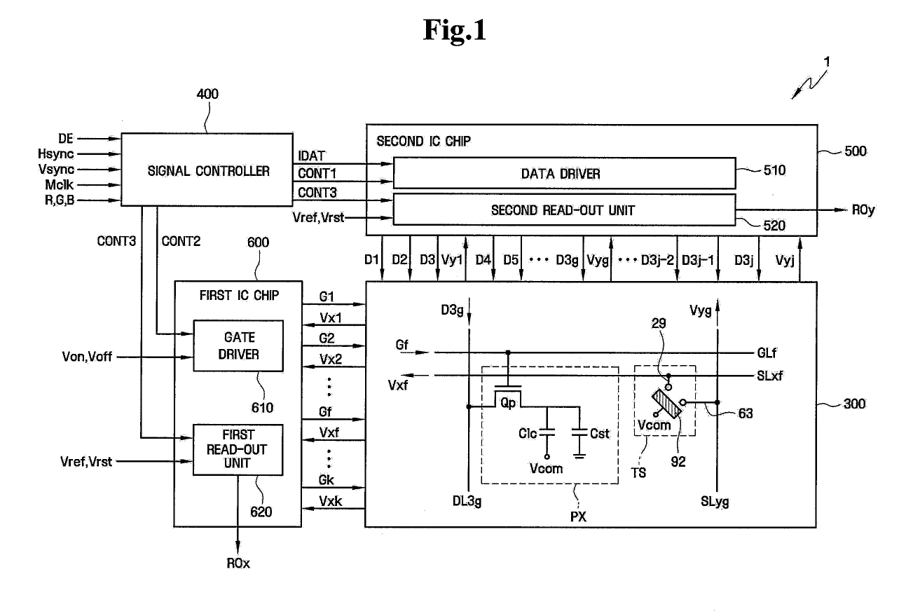

Hereinafter, a touch screen display device 1 according to an exemplary embodiment of the present disclosure will be described with reference to FIG. 1. FIG. 1 is a block diagram of the touch screen display device 1 according to the exemplary embodiment of the present disclosure. Referring to FIG. 1, the touch screen display device 1 includes a touch screen display panel 300, a signal controller 400, a first integrated circuit (IC) chip 600, and a second IC chip 500.

The touch screen display panel 300 includes a plurality of gate lines (not shown) which extend in a first direction, a plurality of data lines DL1 through DL3j (not shown) which extend in a second direction that crosses the first direction, a plurality of pixels PX which are defined in regions where the gate lines GL1 through GLk and the data lines DL1 through DL3j cross each other, respectively, a plurality of first sensing lines SLx1 through SLxk (not shown) which extend substantially parallel to the first direction, a plurality of second sensing lines SLy1 through SLyj (not shown) which extend substantially parallel to the second direction, and a plurality of touch sensors TS which are defined in regions where the first sensing lines SLx1 through SLxk and the second sensing lines SLy1 through SLyj cross each other, respectively.

The gate lines GL1 through GLk respectively receive a plurality of gate signals G1 through Gk from the first IC chip 600, and the data lines DL1 through DL3j respectively receive image data voltages D1 through D3j from the second IC chip 500. In addition, the first sensing lines SLx1 through SLxk respectively transmit a plurality of output signals Vx1 through Vxk to the first IC chip 600, and the second sensing lines SLy1 through SLyj respectively transmit a plurality of output signals Vy1 through Vyj to the second IC chip 500.

In FIG. 1, an fth (f=1 to k) gate line GLf, a 3gth (g=1 to j) data line DL3g, and a pixel PX defined in a region where the fth gate line GLf and the 3gth data line DL3g cross each other are illustrated. In addition, an fth (f=1 to k) first sensing line SLxf, a gth (g=1 to j) second sensing line SLyg, and a touch sensor TS defined in a region where the fth first sensing line SLxf and the gth second sensing line SLyg cross each other are illustrated in FIG. 1. Hereinafter, the gate lines GL1 through GLk, the data lines DL1 through DL3j, the pixels PX, the first sensing lines SLx1 through SLxk, the second sensing lines SLy1 through SLyj, and the touch sensors TS will be described by using the fth gate line GLf, the 3gth data line DL3g, the pixel PX, the fth first sensing line SLxf, the gth second sensing line SLyg, and the touch sensor TS as an example.

Referring to an equivalent circuit diagram of a pixel PX illustrated in FIG. 1, the pixel PX includes a switching device Qp which is connected to the fth gate line GLf and the gth data line DL3g, a liquid crystal capacitor Clc, and a storage capacitor Cst. In this case, the switching device Qp is connected to an end of the liquid crystal capacitor Clc and an end of the storage capacitor Cst. The other end of the liquid crystal capacitor Clc may have a common voltage Vcom, and the other end of the storage capacitor Cst may be connected to a ground.

Referring to a diagram of a touch sensor TS illustrated in FIG. 1, the touch sensor TS includes a first sensor electrode 29 which extends from the fth first sensing line SLxf, a second sensor electrode 63 which extends from the gth second sensing line SLyg, and a sensor spacer 92 which contacts the first sensor electrode 29 and the second sensor electrode 63 by an external touch. In one aspect, the sensor spacer 92 may have the common voltage Vcom. As such, when the sensor spacer 92 contacts the first and second sensor electrodes 29 and 63 by an external touch, the respective output signals Vxf and Vyg of the fth first sensing line SLxf and the gth second sensing line SLyg may have the same level as the common voltage Vcom.

The signal controller 400 may receive first image signals R, G and B and output second image signals IDAT corresponding to the first image signals R, G and B. The signal controller 400 may also receive external control signals from an external source and generate a data control signal CONT1 and a gate control signal CONT2. Examples of the external control signals include a vertical synchronization signal Vsync, a horizontal synchronization signal Hsync, a main clock signal Mclk, and a data enable signal DE. The gate control signal CONT2 is used to control the operation of a gate driver 610, and the data control signal CONT1 is used to control the operation of a data driver 510.

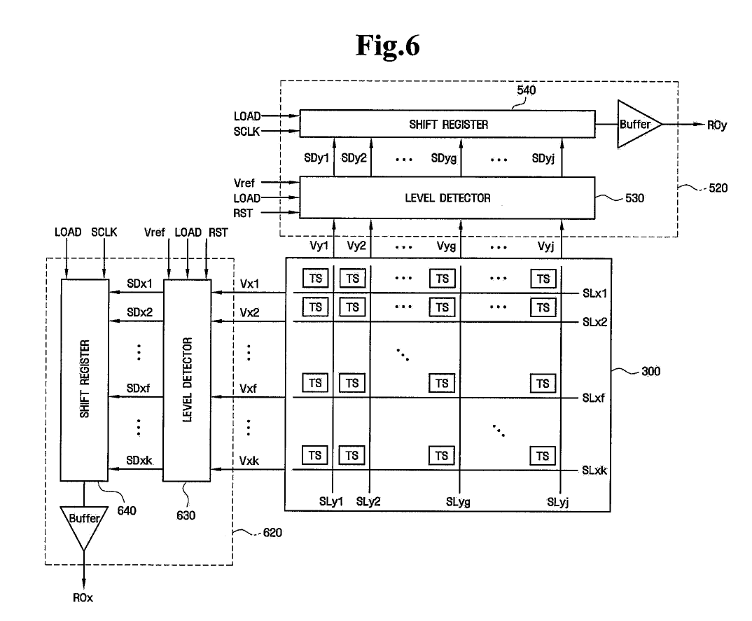

The signal controller 400 may also generate a touch sensing control signal CONT3 and transmit the generated touch sensing control signal CONT3 to each of a first read-out unit 620 and a second read-out unit 520. The touch sensing control signal CONT3 may include a loading signal LOAD (see FIG. 6) and a shift clock signal SCLK (see FIG. 6), which will be described later in relation to the first and second read-out units 620 and 520.

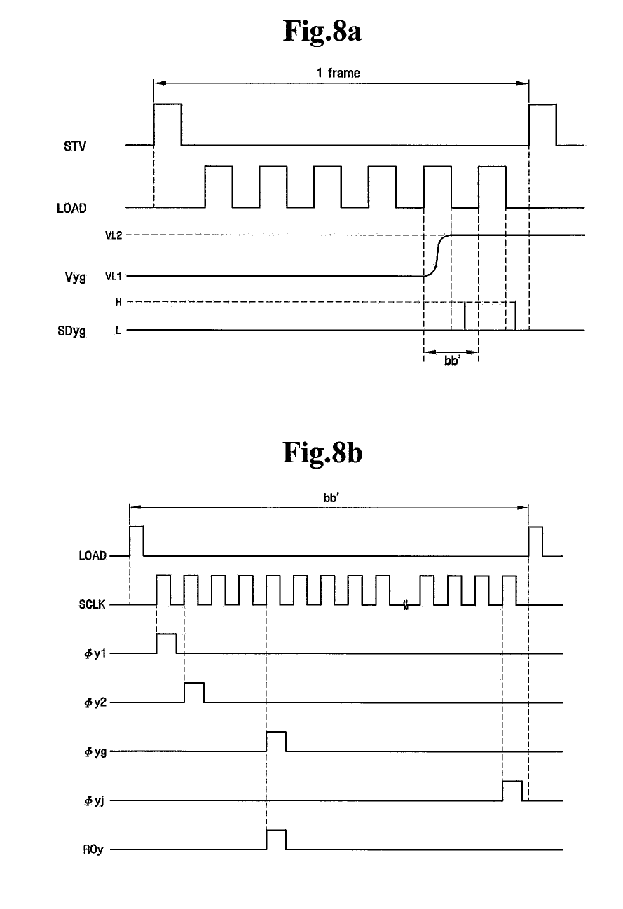

The first IC chip 600 includes the gate driver 610, which transmits the gate signals G1 through Gk to the gate lines GL1 through GLk, respectively, and the first read-out unit 620 which receives the output signals Vx1 through Vxk from the first sensing lines SLx1 through SLxk, respectively. The gate driver 610 receives the gate control signal CONT2 from the signal controller 400 and transmits the gate signals G1 through Gk to the gate lines GL1 through GLk, respectively. The gate control signal CONT2 is used to control the operation of the gate driver 610 and may include a vertical start signal STV (see FIG. 8A) for starting the gate driver 610, a gate clock signal for determining when to output a gate-on voltage Von, and an output enable signal for determining the pulse width of the gate-on voltage Von. Each of the gate signals G1 through Gk may include the gate-on voltage Von and a gate-off voltage Voff provided by a gate on/off voltage generator (not shown).

The first read-out unit 620 may receive the respective output signals Vx1 through Vxk of the first sensing lines SLx1 through SLxk and output a first read-out signal ROx. The first read-out unit 620 may be driven by a reference voltage Vref and a reset voltage Vrst which are received from an external source. The first read-out unit 620 may be described in detail later with reference to FIGS. 6 through 8B.

The first IC chip 600 may include a plurality of pins (not shown) from which the gate signals G1 through Gk are output, respectively, and a plurality of pins (not shown) to which the output signals Vx1 through Vxk of the first sensing lines SLx1 through SLxk are input, respectively. The pins from which the gate signals G1 through Gk are output and the pins to which the output signals Vx1 through Vxk are input may be alternately arranged.

However, the arrangement of pins included in the first IC chip 600 is not limited to the above example and may vary according to the resolution of a touch screen function that is to be implemented. For example, two pins from which the gate signals G1 through Gk are output and one pin to which the output signals Vx1 through Vxk of the first sensing lines SLx1 through SLxk are input may be alternately arranged.

In one aspect, the gate driver 610 and the first read-out unit 620 of the first IC chip 600 may be separated from each other and driven independently. Since the gate driver 610 and the first read-out unit 620 are implemented in a single chip, manufacturing costs may be reduced. The second IC chip 500 includes the data driver 510 which transmits the image data voltages D1 through D3j to the data lines (not shown), respectively, and the second read-out unit 520 which receives the output signals Vy1 through Vyk from the second sensing lines SLy1 through SLyk, respectively.

The data driver 510 receives the data control signal CONT1 from the signal controller 400 and applies the image data voltages D1 through D3j corresponding to the second image signals IDAT to the data lines DL1 through DL3j, respectively. The data control signal CONT1 is used to control the operation of the data driver 510. The data control signal CONT1 may include a horizontal start signal for starting the data driver 510 and an output instruction signal for instructing the output of the image data voltages D1 through D3j.

The second read-out unit 520 may receive the respective output signals Vy1 through Vyk of the second sensing lines SLy1 through SLyk and output a second read-out signal ROy. The second read-out unit 620 may be driven by a reference voltage Vref and a reset voltage Vrst which are received from an external source. The second read-out unit 520 will be described in detail later with reference to FIGS. 6 through 8B.

The second IC chip 500 may include a plurality of pins (not shown) from which the image data voltages D1 through D3j are output, respectively, and a plurality of pins (not shown) to which the output signals Vy1 through Vyk of the second sensing lines SLy1 through SLyk are input, respectively. The image data voltages D1 through D3j may be divided into red, green and blue image data voltages. For example, reference characters D1, D4, . . . , D3j−2 may indicate the red image data voltages, reference characters D2, D5, . . . , D3j−1 may indicate the green image data voltages, and reference characters D1, D4, . . . , D3g, . . . , D3j may indicate the blue image data voltages. Three pins from which the red, green and blue image data voltages are output and a pin to which the respective output signals Vy1 through Vyk of the second sensing lines SLy1 through SLyk are input may be alternately arranged. As in the first IC chip 600, however, the arrangement of pins included in the second IC chip 500 is not limited to the above example and may vary according to the resolution of a touch screen function that is to be implemented.

In one aspect, the data driver 510 and the second read-out unit 520 of the second IC chip 500 may be separated from each other and driven independently. Since the data driver 510 and the second read-out unit 520 are implemented in a single chip, manufacturing costs may be reduced.

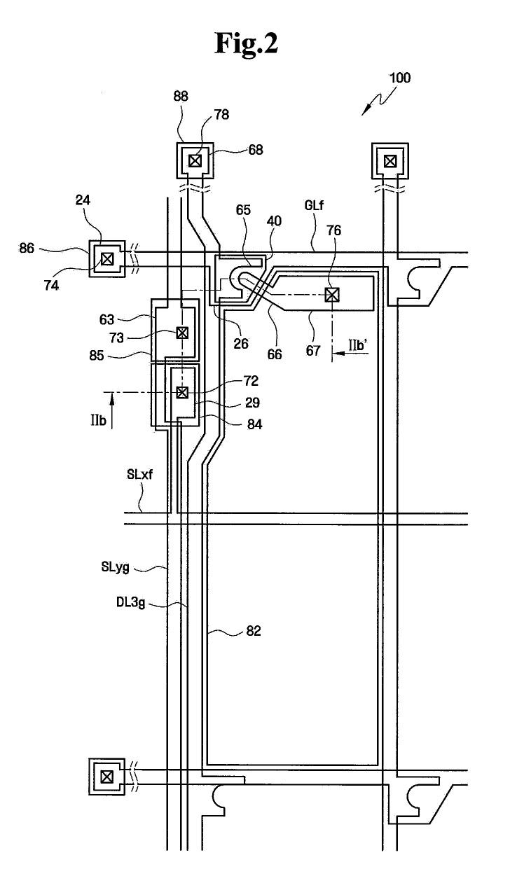

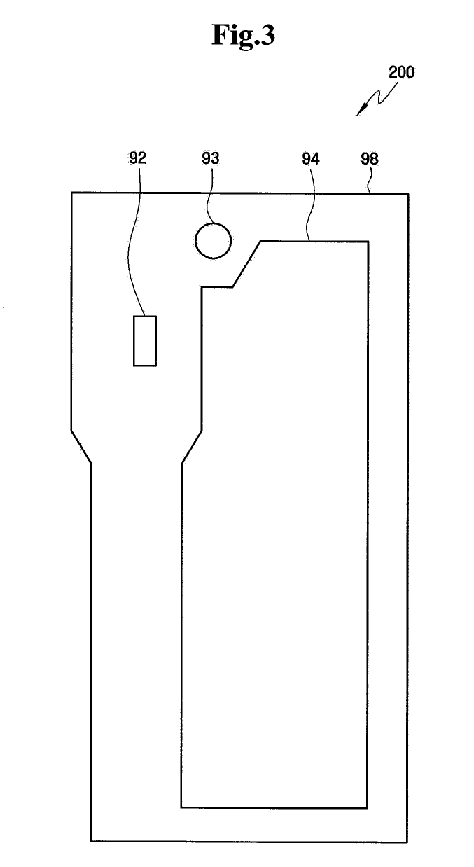

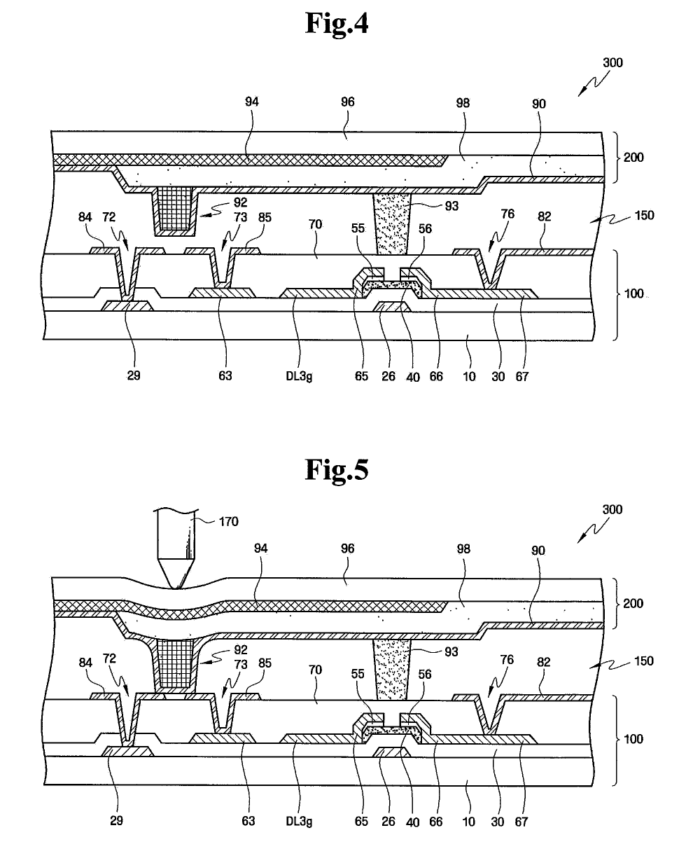

The touch screen display panel 300 of FIG. 1 will now be described in more detail with reference to FIGS. 2 through 5, in accordance with one or more embodiments of the present disclosure. FIG. 2 is the layout of a first display panel 100 included in the touch screen display panel 300 of FIG. 1. FIG. 3 is the layout of a second display panel 200 included in the touch screen display panel 300 of FIG. 1. FIG. 4 is a cross-sectional view of the touch screen display panel 300 of FIG. 1 taken along a line IIb-IIb′ of FIG. 2. FIG. 5 is a cross-sectional view of the touch screen display panel 300 for explaining a process of inputting location information by pressing a point on the touch screen display panel 300 of FIG. 4.

The touch screen display panel 300 includes the first display panel 100 (see FIG. 4), the second display panel 200 (see FIG. 4) which faces the first display substrate 100, and a liquid crystal molecule layer 150 (see FIG. 4) which is interposed between the first and second display panels 100 and 200. The first display panel 100 includes the gate lines GL1 through GLk, the data lines DL1 through DL3j, the pixels PX, the first sensing lines SLx1 through SLxk, and the second sensing lines SLy1 through SLyj. The second display panel 200 includes a common electrode 90 (see FIG. 4) and the sensor spacer 92 (see FIG. 4).

Referring to FIGS. 2 and 4, the fth gate line GLf which extends in the first direction and a gate electrode 26 which protrudes from the fth gate line GLf are formed on an insulating substrate 10 of the first display panel 100. A gate line end 24 is formed at an end of the fth gate line GLf (see FIG. 1). The gate line end 24 receives the gate signal Gf from an external source and transmits the received gate signal Gf to the fth gate line GLf.

In addition, the fth first sensing line SLxf and the first sensor electrode 29 are formed on the insulating substrate 10. The fth first sensing line SLxf is separated from the fth gate line GLf and extends substantially parallel to the first direction. The first sensor electrode 29 protrudes from the fth first sensing line SLxf and has a wide portion. The first sensor electrode 29 is a terminal of the touch sensor TS (see FIG. 1) and connected to a first sensor pad 84 by a contact hole 72. When external pressure is applied, the first sensor electrode 29 is electrically connected to the common electrode 90 on the sensor spacer 92 and thus provides information regarding a point on the touch screen display panel 300 onto which the external pressure was applied.

A gate insulating film 30 is formed on the fth gate line GLf, the gate line end 24, the gate electrode 26, the fth first sensing line SLxf, and the first sensor electrode 29. Then, an active layer 40 is formed on the gate insulating film 30, and ohmic contact layers 55 and 56 are formed on the active layer 40.

The 3gth data line DL3g and a drain electrode 66 are formed on the ohmic contact layers 55 and 56 and the gate insulating film 30. The 3gth data line DL3g extends long in the second direction and crosses the fth gate line GLf. In addition, a source electrode 65 branches off from the 3gth data line DL3g onto the active layer 40. A data line end 68 is formed at an end of the 3gth data line DL3g. The data line end 68 receives the image data voltage D3g (see FIG. 1) from an external source and applies the received image data voltage D3g to the 3gth data line DL3g. The drain electrode 66 is separated from the source electrode 65 and is disposed on the active layer 40 to face the source electrode 65. The drain electrode 66 includes a drain electrode extension portion 67 on which a contact hole 76 is disposed.

The gth second sensing line SLyg and the second sensor electrode 63 are formed on the gate insulating film 30. The gth second sensing line SLyg is separated from the 3gth data line DL3g and extends substantially parallel to the second direction. The second sensor electrode 63 protrudes from the gth second sensing line SLyg and has a wide portion. The second sensor electrode 63 is a terminal of the touch sensor TS (see FIG. 1) and connected to a second sensor pad 85 by a contact hole 73. When external pressure is applied, the second sensor electrode 63 is electrically connected to the common electrode 90 on the sensor spacer 92 and thus provides information regarding a point on the touch screen display panel 300 onto which the external pressure was applied.

The source electrode 65 at least partially overlaps the active layer 40, and the drain electrode 66 faces the source electrode 65 and at least partially overlaps the active layer 40. Here, the ohmic contact layers 55 and 56 are interposed between the active layer 40 and the source electrode 65 and between the active layer 40 and the drain electrode 66, respectively, to reduce contact resistance between them.

A passivation layer 70, which is made of an insulating film, is formed on the 3gth data line DL3g, the source electrode 65, the drain electrode 66, the drain electrode extension portion 67, the data line end 68, the second sensor electrode 63, the gth second sensing line SLyg, and an exposed portion of the active layer 40. In the passivation layer 70, the contact holes 73, 76 and 78, which expose the second sensor electrode 63, the drain electrode 66, and the data line end 68, respectively, are formed. In addition, contact holes 72 and 74, which expose the first sensor electrode 29 and the gate line end 24, respectively, are formed in the passivation layer 70 and the gate insulating film 30.

A pixel electrode 82 is formed on the passivation layer 70. The pixel electrode 82 is electrically connected to the drain electrode 66 by the contact hole 76 and formed after the shape of the pixel PX. In addition, a gate line pad 86 and a data line pad 88, which are connected to the gate line end 24 and the data line end 68 by the contact holes 74 and 78, respectively, are formed on the passivation layer 70.

Referring to FIGS. 3 and 4, a black matrix 94, which prevents leakage of light, and a color filter 98, which is disposed on the pixel PX, are formed on an insulating substrate 96 of the second display panel 200. The sensor spacer 92 is formed on the color filter 98. The common electrode 90, which is made of a transparent conductive material, is formed on the black matrix 94, the color filter 98, and the sensor spacer 92. A support spacer 93 is formed on the common electrode 90. The support spacer 93 is interposed between the first display panel 100 and the second display panel 200 to support them and forms a predetermined cell gap.

Referring to FIGS. 4 and 5, when a point on the touch screen display panel 300 is pressed, location information of the point is input as follows. When no external pressure is applied onto the touch screen display panel 300, the sensor spacer 92 is separated from the first display panel 100. When external pressure is applied, the common electrode 90 on the sensor spacer 92 contacts and thus is electrically connected to the first sensor pad 84 and the second sensor pad 85. That is, referring to FIG. 5, when a user presses a point on the touch screen display panel 300 by using his or her finger or a pen 170, the common electrode 90 on the sensor spacer 92 is electrically connected to the first and second sensor pads 84 and 85 on the first display panel 100 at the point. Accordingly, a signal indicating location information of the point is generated.

The first sensing lines SLx1 through SLxk, the first read-out unit 620, which receives the output signals Vx1 through Vxk of the first sensing lines SLx1 through SLxk, the second sensing lines SLy1 through SLyj, and the second read-out unit 520 which receives the output signals Vy1 through Vyj of the second sensing lines SLy1 through SLyj will now be described in more detail with reference to FIGS. 6 through 8B.

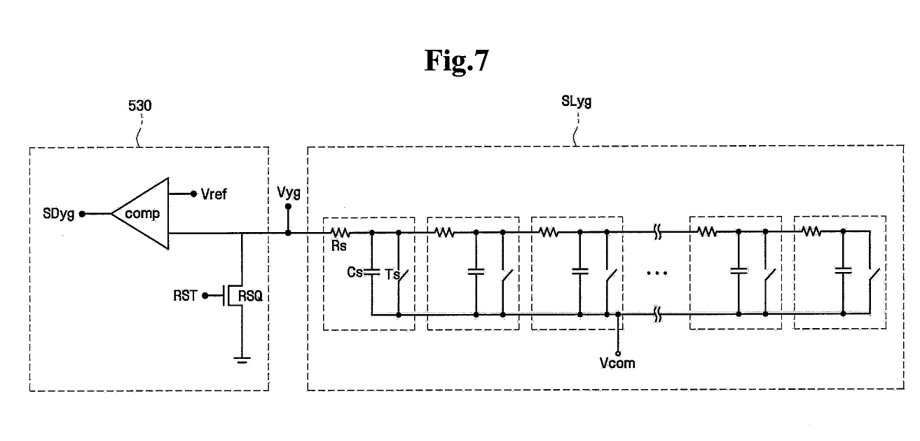

FIG. 6 is a block diagram for explaining the first and second sensing lines SLx1 through SLxk and SLy1 through SLyj and the first and second read-out units 520 and 620. For simplicity of description, the gate lines GL1 through GLk, the data lines DL1 through DL3j, and the pixels PX included in the touch screen display panel 300 are not illustrated in FIG. 6, unlike in FIG. 1. FIG. 7 is a circuit diagram for explaining the gth second sensing line SLyg and a level detector 530 connected to the gth second sensing line SLyg. That is, FIG. 7 partially illustrates the gth second sensing line SLyg and the level detector 530 which receives the output signal Vyg from the gth second sensing line SLyg.

When any one of the touch sensors TS arranged in the touch screen display panel 300 is turned on by an external touch, one of the output signals Vx1 through Vxk of the first sensing lines SLx1 through SLxk, which is connected to the touch sensor TS, and one of the output signals Vy1 through Vyk of the second sensing lines SLy1 through SLyk, which is connected to the touch sensor TS, transit from a first voltage level VL1 (see FIG. 8A) to a second voltage level VL2 (see FIG. 8A).

Specifically, referring to FIG. 7, each of the touch sensors TS illustrated in FIG. 6 is a switching device which is turned on by an external touch. In FIG. 7, resistance and capacitance of the gth second sensing line SLyg are indicated by reference characters Rs and Cs, respectively.

When one of the touch sensors TS, which is connected to the gth second sensing line SLyg, is turned on by an external touch, the touch sensor TS, i.e., the switching device, may be closed, and, for example, the common voltage Vcom may be applied to the gth second sensing line SLyg. Accordingly, the level of the output signal Vyg of the gth second sensing line SLyg may become the second voltage level VL2, e.g., the level of the common voltage Vcom.

When there is no external touch, all touch sensors TS, i.e., the switching devices, which are connected to the gth second sensing line SLyg, are opened. Accordingly, the output signal Vyg of the gth second sensing line SLyg floats, and the level of the output signal Vyg of the gth second sensing line SLyg may become the first voltage level VL1.

Referring back to FIG. 6, the first read-out unit 620 includes a level detector 630, a shift register 640, and an output buffer (Buffer). The level detector 630 converts the output signals Vx1 through Vxk of the first sensing lines SLx1 through SLxk into digital data SDx1 through SDxk which is logic high or low and outputs the digital data SDx1 through SDxk. The shift register 640 sequentially outputs the digital data SDx1 through SDxk, and the output buffer (Buffer) amplifies the output digital data SDx1 through SDxk of the shift register 640 and outputs the first read-out signal ROx.

The second read-out unit 520 includes the level detector 530, a shift register 540, and an output buffer (Buffer). The level detector 530 converts the output signals Vy1 through Vyj of the second sensing lines SLy1 through SLyj into digital data SDy1 through SDyj which is logic high or low and outputs the digital data SDy1 through SDyj. The shift register 540 sequentially outputs the digital data SDy1 through SDyj, and the output buffer (Buffer) amplifies the output digital data SDy1 through SDyj of the shift register 540 and outputs the second read-out signal ROy.

The level detector 530 of the second read-out unit 520 will now be described in more detail with reference to FIG. 7. The following description may also apply to the level detector 630 of the first read-out unit 620. The level detector 530 may include a comparator comp which converts the output signals Vy1 through Vyi of the second sensing lines SLy1 through SLyj into the digital data SDy1 through SDyj which is logic high or logic low.

The comparator comp receives the reference voltage Vref and the output signals Vy1 through Vyj of the second sensing lines SLy1 through SLyj and outputs the digital data SDy1 through SDyj which is logic high or logic low. Here, the level of the reference voltage Vref may be between the first and second voltage levels VL1 and VL2 (see FIG. 8A) that the output signals Vy1 through Vyj may have. In one aspect, the level of the reference voltage Vref may be externally controlled according to the first and second voltage levels VL1 and VL2. When the first voltage level VL1 is input, the comparator comp may output the digital data SDx1 through SDxk or SDy1 through SDyj which is logic high. When the second voltage level VL2 is input, the comparator comp may output the digital data SDx1 through SDxk or the SDy1 through SDyj which is logic low. The level detector 530 may include a reset device RSQ connected to a node which outputs the output signals Vy1 through Vyj of the second sensing lines SLy1 through SLyj.

When a reset voltage RST is applied to the reset device RSQ, electric charges in the second sensing lines SLy1 through SLyj may be discharged. The second read-out unit 520 (or the first read-out unit 620) initiates its read-out operation in response to the loading signal LOAD, as will be described later. Before the read-out operation, the reset voltage RST is applied to the reset device RSQ to drive the reset device RSQ. Since the reset device RSQ resets the level of the output signals Vy1 through Vyj of the second sensing lines SLy1 through SLyj to the first voltage level VL1, malfunction of the second read-out unit 520 may be prevented.

The operation of the second read-out unit 520 will now be described in more detail with reference to FIGS. 6, 8A and 8B and by using a case where the touch sensor TS, which is defined in a region where the fth first sensing line SLxf and the gth second sensing line SLyg cross each other, is turned on by an external touch as an example. The following description may also apply to the first read-out unit 620.

FIGS. 8A and 8B are timing diagrams of signals which are input or output to/from the second read-out unit 520 of FIG. 6. In particular, FIG. 8B is a timing diagram of the signals in a section bb′ of FIG. 8A.

Referring to FIG. 8A, a frame during which an image is displayed on the touch screen display panel 300 may be initiated by a pulse of the vertical start signal STV. A period of time between a rising edge of a pulse of the vertical start signal STV and that of a next pulse may correspond to a frame.

The loading signal LOAD having a number of pulses during a frame is input to the second read-out unit 520. The second read-out unit 520 initiates the read-out operation in response to the loading signal LOAD. Here, the second read-out unit 520 may perform the read-out operation an equal number of times to the number of pulses of the loading signal LOAD. For example, the loading signal LOAD illustrated in FIG. 8A has six pulses. Thus, the second read-out unit 520 may perform the read-out operation six times.

In FIG. 8A, the output signal Vyg of the gth second sensing line SLyg transits to the second voltage level VL2 from the first voltage level VL1 due to an external touch. A section in which the loading signal LOAD is at a high level and the voltage level of the output signal Vyg of the gth second sensing line SLyg is the second voltage level VL2 includes a point at which the digital data Sdyg output from the level detector 530 is logic high.

Referring to FIG. 8B, the shift clock signal SCLK includes a plurality of pulses between sections in which the loading signal LOAD is at a high level. Each pulse of the shift clock signal SCLK causes the shift register 540 to sequentially output the digital data SDy1 through SDyj which is logic high or logic low. That is, the shift register 540 may be synchronized with each rising edge of the shift clock signal SCLK and receive timing signals Φy1, Φy2, . . . , Φyg, . . . , Φyj which cause the shift register 540 to sequentially output the digital data SDy1 through SDyj which is logic high or logic low. Accordingly, the shift register 540 may sequentially output the digital data SDy1 through SDyj which is logic high or logic low.

Consequently, the shift register 540 may output the second read-out signal ROy which contains information indicating that the touch sensor TS connected to the gth second sensing line SLyg has been touched. Similarly, the first read-out unit 620 may output the first read-out signal ROx which contains information indicating that the touch sensor TS connected to the fth first sensing line SLxf has been touched. A determination unit (not shown) may receive the first read-out signal ROx and the second read-out signal ROy and determine that a point at which the fth first sensing line SLxf and the gth second sensing line SLyg cross each other has been touched.

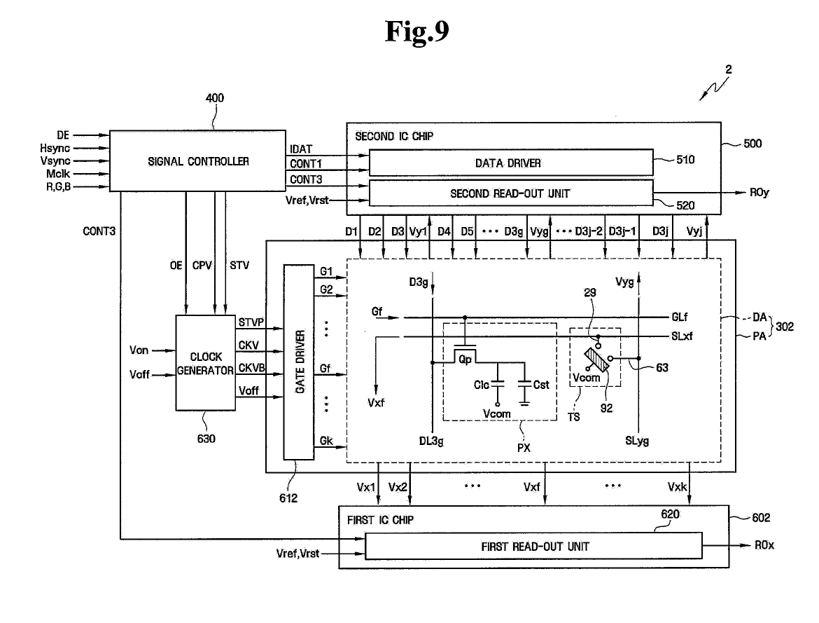

Hereinafter, a touch screen display device 2 according to another exemplary embodiment of the present disclosure will be described with reference to FIG. 9. FIG. 9 is a block diagram of the touch screen display device 2 according to another exemplary embodiment of the present disclosure. Elements substantially identical to those of the previous embodiment are indicated by like reference numerals, and thus their description will be omitted.

Referring to FIG. 9, the touch screen display device 2 includes a touch screen display panel 302, a signal controller 400, a clock generator 630, a first IC chip 602, and a second IC chip 500. The touch screen display panel 302 is divided into a display unit DA on which images are displayed and a non-display unit PA on which no images are displayed.

As described above in the previous embodiment, the display unit DA includes a plurality of gate lines GL1 through GLk (not shown), a plurality of data lines DL1 through DL3j (not shown), a plurality of pixels PX, a plurality of first sensing lines SLx1 through SLxk (not shown), a plurality of second sensing lines SLy1 through SLyj (not shown), and a plurality of touch sensors TS. The non-display unit PA is a region where no images are displayed since a first display panel (indicated by reference numeral 100 in FIG. 4) is wider than a second display panel (indicated by reference numeral 200 in FIG. 4).

A gate driver 612 may be mounted on the non-display unit PA. The gate driver 612 is enabled by a first scan start signal STVP, generates a plurality of gate signals G1 through Gk by using a clock signal CKV, a clock bar signal CKVB and a gate-off voltage Voff, and sequentially transmits the gate signals G1 through Ok to the gate lines GL1 through GLk, respectively. The signal controller 400 may provide a second scan start signal STV, a first clock generation control signal OE, and a second clock generation control signal CPV to the clock generator 630.

The clock generator 630 may receive the second scan start signal STV, the first clock generation control signal OE and the second clock generation control signal CPV from the signal controller 400 and receive a gate-on voltage Von and the gate-off voltage Voff from a voltage generator (not shown). Then, the clock generator 630 may provide the first scan start signal STVP, the clock signal CKV, the clock bar signal CKVB, and the gate-off voltage Voff to the gate driver 612.

Specifically, the clock generator 630 may receive the second scan start signal STV and output the first scan start signal STVP. In addition, the clock generator 630 may receive the first clock generation control signal OE and the second clock generation control signal CPV and output the clock signal CKV and the clock bar signal CKVB. The clock signal CKV is a revere phase signal of the clock bar signal CKVB.

The first IC chip 602 includes a first read-out unit 620. Unlike in the previous embodiment, in the present embodiment, the gate driver 612 may be mounted on the non-display unit PA of the touch screen display panel 302.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A touch screen display device comprising:
a touch screen display panel comprising a plurality of gate lines that extend in a first direction, a plurality of data lines that extend in a second direction, a plurality of pixels, a plurality of first sensing lines that extend substantially parallel to the first direction, a plurality of second sensing lines that extend substantially parallel to the second direction, and a plurality of touch sensors;
a first driver comprising a gate driver that transmits a plurality of gate signals to the gate lines, respectively, and a first read-out unit that receives respective output signals of the first sensing lines; and
a second driver comprising a data driver which applies a plurality of image data voltages to the data lines, respectively, and a second read-out unit that receives respective output signals of the second sensing lines.

2. The device of claim 1, wherein the first driver comprises a plurality of pins from which the gate signals are output and a plurality of pins to which the output signals of the first sensing lines are input, and wherein the pins from which the gate signals are output and the pins to which the output signals of the first sensing lines are input are alternately arranged.

3. The device of claim 1, wherein the second driver comprises a plurality of pins from which the image data voltages are output and a plurality of pins to which the output signals of the second sensing lines are input, and wherein the image data voltages are divided into a red image data voltage, a green image data voltage and a blue image data voltage, and three pins from which the red image data voltage, the green image data voltage and the blue image data voltage are output and a pin to which the output signals of the second sensing lines are input are alternately arranged.

4. The device of claim 1, wherein the gate driver and the first read-out unit are driven independently, and the data driver and the second read-out unit are driven independently.

5. The device of claim 1, wherein each of the touch sensors comprises a switching device adapted to be turned on by an external touch.

6. The device of claim 1, wherein, when any one of the touch sensors, which are connected to the first and second sensing lines, respectively, is turned on by an external touch, output signals of first and second sensing lines, which are connected to the turned-on touch sensor, transit from a first voltage level to a second voltage level.

7. The device of claim 1, wherein each of the first and second read-out units comprises a comparator that converts the output signals of the first and second sensing lines into digital data which is logic high or logic low.

8. The device of claim 1, wherein each of the first and second read-out units comprises a comparator that compares a reference voltage with the output signals of the first and second sensing lines, and wherein the reference voltage is adapted to be externally controlled.

9. The device of claim 1, further comprising a reset device connected to a node connected to the first and second read-out units and the first and second sensing lines and discharges electric charges from the first and second sensing lines.

10. The device of claim 9, wherein each of the first and second read-out units initiates a read-out operation in response to a loading signal, and the reset device operates before the read-out operation.

11. The device of claim 1, wherein each of the first and second read-out units comprises a level detector that converts the output signals of the first and second sensing lines into digital data, which is logic high or logic low, and outputs the digital data which is logic high or logic low.

12. The device of claim 11, wherein each of the first and second read-out units comprises a shift register adapted to sequentially output the digital data.

13. A touch screen display device comprising:
a touch screen display panel comprising a plurality of gate lines that extend in a first direction, a plurality of data lines that extend in a second direction, a plurality of pixels, a plurality of first sensing lines that extend substantially parallel to the first direction, a plurality of second sensing lines that extend substantially parallel to the second direction, a plurality of touch sensors, and a gate driver that transmits the gate signals to the gate lines, respectively;
a first driver comprising a first read-out unit that receives respective output signals of the first sensing lines; and
a second driver comprising a data driver that applies a plurality of image data voltages to the data lines, respectively, and a second read-out unit which receives respective output signals of the second sensing lines.

14. The device of claim 13, wherein the second driver comprises a plurality of pins from which the image data voltages are output and a plurality of pins to which the output signals of the second sensing lines are input, and wherein the image data voltages are divided into a red image data voltage, a green image data voltage and a blue image data voltage, and three pins from which the red image data voltage, the green image data voltage and the blue image data voltage are output and a pin to which the output signals of the second sensing lines are input are alternately arranged.

15. The device of claim 13, wherein the data driver and the second read-out unit are driven independently.

16. The device of claim 13, wherein each of the touch sensors comprises a switching device that is adapted to be turned on by an external touch.

17. The device of claim 13, wherein, when any one of the touch sensors, which are connected to the first and second sensing lines, respectively, is turned on by an external touch, output signals of first and second sensing lines, which are connected to the turned-on touch sensor, transit from a first voltage level to a second voltage level.

18. The device of claim 13, wherein each of the first and second read-out units comprises a comparator that converts the output signals of the first and second sensing lines into digital data which is logic high or logic low.

19. The device of claim 13, wherein each of the first and second read-out units comprises a comparator that compares a reference voltage with the output signals of the first and second sensing lines, and the reference voltage is adapted to be externally controlled.

20. The device of claim 13, further comprising a reset device that is connected to a node connected to the first and second read-out units and the first and second sensing lines and discharges electric charges from the first and second sensing lines.
